(19) United States
(12) Patent Application Publication
(10) Pub. No.: US 2016/0212378 A1
(43) Pub. Date: Jul. 21, 2016

(54) METHOD AND SYSTEM TO COUNSEL INDIVIDUALS AND COUPLES THROUGH VIDEO CONFERENCING USING PRINCIPLES OF ASTROLOGY

(71) Applicant: Krishan Kumar Advaney, Prague (CZ)

(72) Inventor: Krishan Kumar Advaney, Prague (CZ)

(21) Appl. No.: 14/600,314

(22) Filed: Jan. 20, 2015

(51) Int. Cl. H04N 7/15; G09B 5/06

(52) U.S. Cl. CPC H04N 7/15; G09B 5/06

(57) ABSTRACT

Described herein is a method and system to counsel individuals and couples who may or may not be in a relationship, through video conferencing and through the use of astrology as the principal tool. In one embodiment of the invention, subscribers, or users of the counselling service are connected to an astrologer for a period of time. During that time the users have a real-time conversation with the astrologer, individually or jointly. The astrologer, after the initial discussion, which may include the personality analysis of each individual user subscriber, proceeds with the counselling session. At the end of the first session, it shall be decided mutually, between the astrologer and the user subscriber, or user subscribers, if further counselling sessions are required and if the counselling is to continue into further sessions.

### BACKGROUND OF THE INVENTION

Counselling services of all kinds have been around for a long time. However, today's fast paced lifestyles have caused single people and people in relationships to come under increasing time pressure. Such lifestyles leave little time to be able to seek counselling at the right time.

Additionally, the inventor of the system believes, God or the Universe define the path of our destiny and leave it unto us to decide what we plant along that path. Is that going to be flowers and fragrances or cacti? The inventor with his humanist approach will guide, through the counseling service, individuals and couples to lead a more fulfilling life.

This is an astrology based counseling service. Beginning with complete study of the astrological charts of the user subscribers, the personality of each user subscriber is analyzed based on the date and place of birth of the user subscriber or the date, time and place of birth of the user subscriber. After this the astrologer who is also the counselor shall meet over a video conference with the user subscriber or the user subscribers for the first counseling session. Although, people suffer through human predicaments and we all have our needs, we are as people, adept at creating happiness once we have identified the causes of distress. In the case of couples, it is important to determine, what part of the relationship they would like to change. The battle is usually half won once these areas are identified with the assistance of the astrologer. The rest can usually be achieved through further counseling with the astrologer.

In this Web based, or online counseling service an individual or a couple first become subscribers by completing a form in which they give their name, date of birth, place of birth when known, by the user subscribers, the time of birth and the geographic location. The individual or the couple then seeks an appropriate time with the astrologer by selecting a suitable date and time available, through the web site.

The existence of God or the effect of the energies of the Universe and astrology are a matter of faith and cannot be patented. What is being asked to be patented is the Web based counseling service or online counseling service, using the principles of astrology.

### BRIEF SUMMARY OF THE INVENTION

Briefly described the present invention comprises an online counseling service based on the principles of astrology. The method has an astrologer who is also the counselor who is at one remote location and user subscriber or user subscribers who is or are at other remote location or locations.

Another aspect of the invention is that the astrologer who is also the counselor and the user subscriber or user subscribers connect with each other through their personal computing device using the internet.

Yet another aspect of the invention is that the user subscriber or the user subscribers have paid a predetermined fees using his, her, or their credit card, debit card or through bank transfer into the account of the counseling service.

Yet another aspect of the invention is that the user subscriber or the user subscribers have chosen a convenient and available time on the web site of the counseling service for the counseling session or sessions.

The method has the astrologer who is also the counselor analyses the personality traits of the user subscriber or the user subscribers and determines if it shall be possible to assist the user subscribers to mend their relationship.

Yet another aspect of the invention is that the astrologer who is also the counselor and the user subscriber or user subscribers meet over video conference sessions for the purposes of counseling.

Thus the counseling begins.

### BRIEF DESCRIPTION OF THE DRAWINGS

FIG. 1 is a view of the astrologer who is also the counselor (1) on his personal computing device and a user subscriber (2) on his or her personal computing device, at a remote location, connected through the internet for a video conferencing session.

FIG. 2 is a view of the astrologer who is also the counselor (1) on his personal computing device and two user subscribers (2) and (3), at a remote location, on their personal computing device, connected through the internet for a video conferencing session.

FIG. 3 is a view of the astrologer who is also the counselor (1) on his personal computing device and two user subscribers (2) and (3), at remote locations, on their personal computing devices, connected through the internet for a video conferencing session

### DETAILED DESCRIPTION OF THE INVENTION

Counselling services of all kinds have been around for a long time. However, today's fast paced lifestyles have caused people to come under increasing time pressure. Such lifestyles leave little time to be able to seek counselling at the right time. This counselling service allows for people to receive counselling from the convenience and comfort of their homes, offices or location of their choice.

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents which may be included within the spirit and scope of the invention as defined by the appended claims.

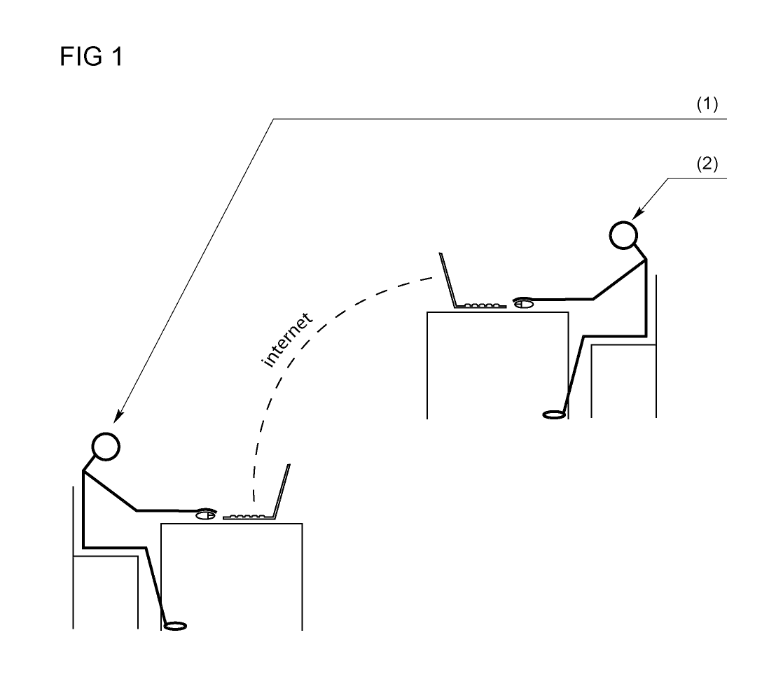

Referring to FIG. 1. This shows the counsellor astrologer (1) at a remote location with his or her personal computing device and the user subscriber (2) at another remote location with his or her personal computing device having a video conference which is a counselling session.

Prior to the beginning of the counselling session, the counsellor astrologer would have already made a personality analysis of the user subscriber or the user subscribers based on the details such as the date and place of birth or the date, time and place of birth that would have been provided to the counsellor astrologer by the user subscriber or the user subscribers. Having concluded at the areas where the user subscriber is compatible with his or her partner and those areas which create a clash, using the principles of astrology, the counsellor first confirms the accuracy of the analysis with the user subscriber or the user subscribers. Once it has been established that the analysis is correct the counsel/or astrologer begins with the counselling session with the aim of achieving the result that the user subscriber or the user subscriber begin to appreciate the strengths of their relationship rather than weaknesses, but understand each others' weaknesses as well, and begin to mend their relationship, within the least possible number of counselling sessions.

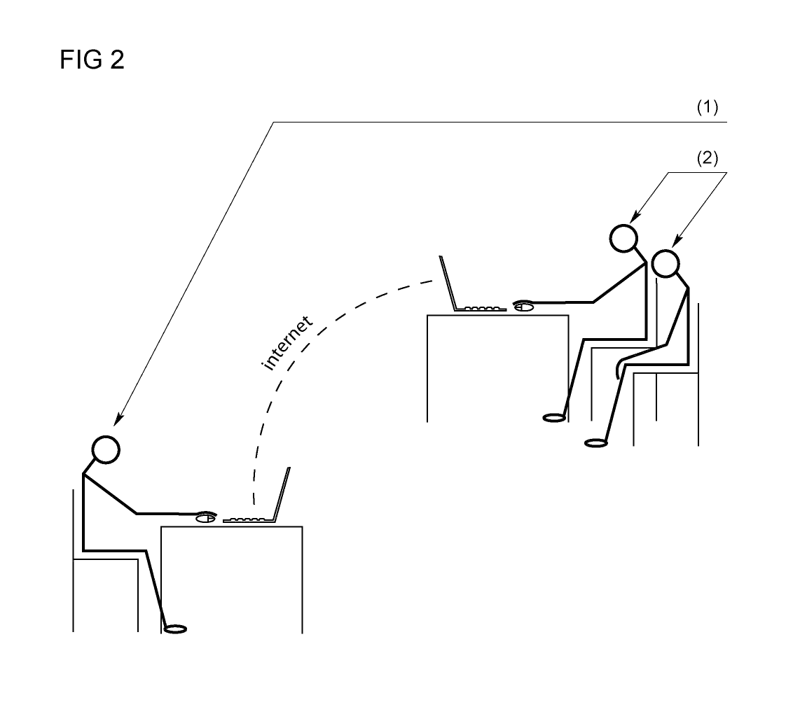

Referring to FIG. 2. This shows the counsellor astrologer (1) at a remote location with his or her personal computing device and the user subscriber along with his or her partner (2) at another remote location on their personal computing device, having a video conference for the counselling session.

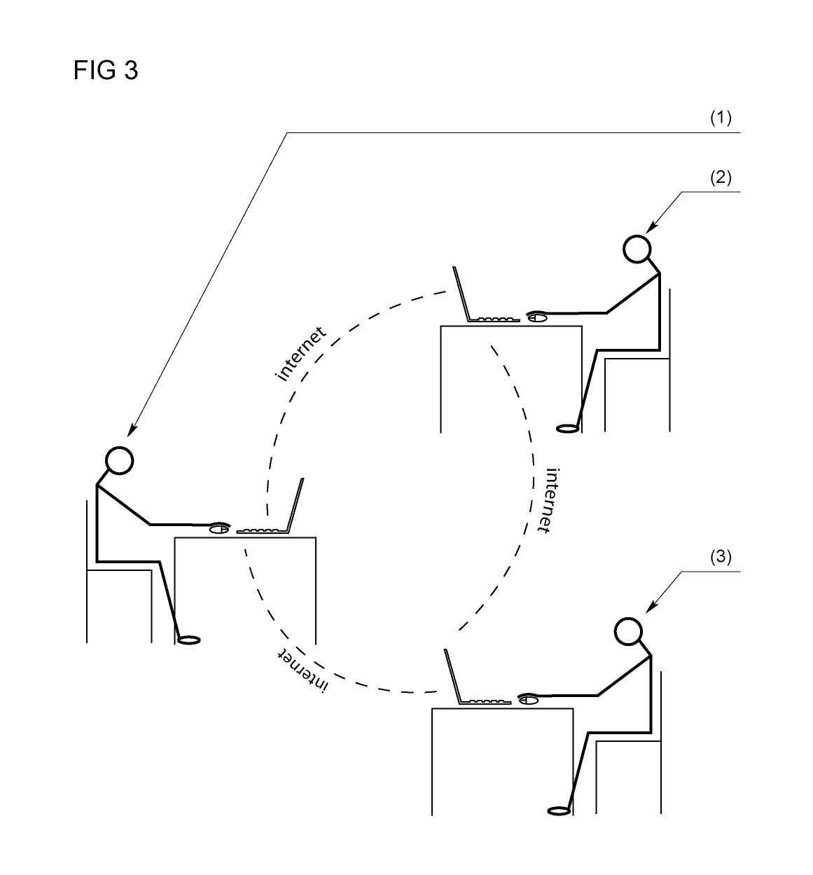

Referring to FIG. 3. This shows the counsellor astrologer (1) at a remote location with his or her personal computing device and one user subscriber (2) with his or her personal computing device at another remote location and the second user subscriber (3) with his or her personal computing device at a third remote location, having a video conference for the counselling session.

The fee associated with the counselling can be determined in many different ways. For instance, in one embodiment the user subscriber or the user subscribers are prompted on the counsellor astrologer's web site the fee that is to be paid before the counselling begins. This fee can be paid for the first session and after the first session the fee can be paid into the counsellor astrologer's account for the subsequent counselling sessions. The counsellor astrologer's account shall be credited before the counselling sessions.

The date and time associated with the counselling sessions can be determined based on the available dates and times with shall be made clear on the counsellor astrologer's web site and these dates and times can be pre selected by the user subscriber or the user subscribers depending upon their convenience as well. The user subscriber or the user subscribers shall have a video conference for the counselling session with the counselling astrologer during this pre selected time. The pre selected duration of the time can be extended at the decision of the counselling astrologer.

In one embodiment of the invention the user subscriber or the user subscribers have a real time conversation with the counsellor astrologer for the counselling sessions.

In another embodiment of the invention the user subscriber or the user subscribers are prompted by the counselling astrologer's web site or if needed through electronic mail or telephone on the instructions on the use of video conferencing including logging in and logging out.

In another embodiment of the invention the user subscriber or the user subscribers and the counselling astrologer may avail of one of the many video conferencing services that are available for video conferencing, for the counselling sessions.

In yet another embodiment of the invention the user subscriber or the user subscribers are prompted by the counselling astrologer's web site about the selection of the date and time of birth or the date, time and place of birth of the user subscriber or the user subscribers.

In yet another embodiment of the invention the user subscriber or the user subscribers are informed of the fee associated with the counselling sessions by the counselling astrologer's web site.

In yet another embodiment of the invention the user subscriber or the user subscribers are informed of the method of counselling by the counsellor astrologer's web site.

What is claimed is :

1. In a video conferencing counselling service, based on astrology, where the personality traits and other traits of user subscriber or user subscribers have been calculated based on astrology, using the user subscriber's date and place of birth or date, time and place of birth, comprising establishing an electronic connection between a first personal computing device of the astrologer and a second personal computing device of a user subscriber or users subscribers and if necessary a third personal computing device of a user subscriber or user subscribers the astrologer and the user subscriber or user subscribers have a person to person counselling session for a duration, using a video conferencing facility, ending said electronic connection between the first said personal computing device and the second said personal computing device or the first said personal computing device and the second and the third said personal computing device after the session is over.

2. The method of claim 1 further comprising counselling sessions jointly between the astrologer and one subscriber or between the astrologer and the subscriber and his or her partner, husband or wife.

3. The method of claim 1, further comprising apprising the first and or the second subscriber whether further counselling sessions are recommended.

4. The method of claim 1, wherein establishing the electronic connection includes utilizing an internet server to establish a connection between the first personal computing device of the said first user and the second personal computing device of the second user and or the third personal computing device of the third user, for using the video conferencing facility.

5. The method of claim 1, wherein establishing the electronic connection includes utilizing the internet to establish a connection between the first personal computing device of the said first user and the second persona computing device of the second user and the or the third personal computing device of the third user, for the video conferencing facility.

5. The method of claim 1, wherein establishing the electronic connection includes utilizing a telephony server to establish a telephone connection between the first personal computing device of the said first user and the second personal computing device of the second user and or the third personal computing device of the third user.

6. The method of claim 1, wherein establishing the electronic connection includes utilizing a telephony server to receive a telephone call from the first, second and or the third user.

7. The method of claim 1, wherein establishing the electronic connection includes utilizing a telephony server to place a telephone cal to the first user and receive a telephone call from the first, second and or the third user.

8. The method of claim 1, wherein the electronic connection includes an audio, video or audio-video connection.

9. The method of claim 1, further comprising, maintaining information about the second and or the third user subscriber.

10. The method of claim 8, wherein said information includes contact information about the users subscribers.

11. The method of claim 1, further comprising informing the said subscriber or subscribers of the time remaining in the predefined duration.

12. The method of claim 1, further comprising prompting the users subscriber or users subscribers to indicate if they would like to continue with the counselling sessions.

13. The method of claim 1, further comprising maintaining an account for the users subscribers.

14. The method of claim 12, wherein the account of the counselling service can receive credit card payments or payments through bank transfer from the subscribers into the account of the counselling service.

15. The method of claim 13, further comprising performing validation to ensure that there are sufficient credits in the users subscribers account for at least one more session if the users subscribers have chosen to continue with the counselling sessions.
